(19) United States
(12) Patent Application Publication
(10) Pub. No.: US 2019/0378095 A1
(43) Pub. Date: Dec. 12, 2019

(54) INFORMATION PROCESSING APPARATUS, WIRELESS COMMUNICATION TERMINAL, AND INFORMATION PROCESSING METHOD

(71) Applicant: TOYOTA JIDOSHA KABUSHIKI KAISHA, Toyota-shi (JP)

(72) Inventors: Yeonseo KIM, Miyoshi-shi (JP); Shin SAKURADA, Toyota-shi (JP); Daisuke TANABE, Nagoya-shi (JP); Ayana TAKESHITA, Toyota-shi (JP); Hiroyuki TOKITA, Toyota-shi (JP); Koichi ASAMOTO, Nagoya-shi (JP)

(73) Assignee: TOYOTA JIDOSHA KABUSHIKI KAISHA, Toyota-shi (JP)

(21) Appl. No.: 16/429,628

(22) Filed: Jun. 3, 2019

(30) Foreign Application Priority Data
Jun. 6, 2018 (JP) 2018-108613

(51) Int. Cl. G06Q 10/10; G06Q 10/02; G06Q 50/30; H04W 4/029; H04W 4/44

(52) U.S. Cl. CPC G06Q 10/1095; G06Q 10/02; H04W 4/44; H04W 4/029; G06Q 50/30

(57) ABSTRACT

When a meet-up schedule is set between users of a first and a second wireless communication terminals that are capable of communication by a first wireless communication scheme, an information processing apparatus notifies the second wireless communication terminal, through the communication network by the first wireless communication scheme, of identification information of the first wireless communication terminal in a second wireless communication scheme. The first wireless communication terminal operates as a transmitter of a first wireless signal according to the second wireless communication scheme, including the identification information of the first wireless communication terminal. The second wireless communication terminal operates as a receiver of a wireless signal according to the second wireless communication scheme, and detects presence of the first wireless communication terminal by receiving the first wireless signal according to the second wireless communication scheme, including the identification information of the first wireless communication terminal.

### CROSS REFERENCE TO RELATED APPLICATION

This application claims the benefit of Japanese Patent Application No. 2018-108613, filed on Jun. 6, 2018, which is hereby incorporated by reference herein in its entirety.

### BACKGROUND

### Technical Field

The present disclosure relates to an information processing apparatus, a wireless communication terminal, and an information processing method.

### Description of the Related Art

Patent document 1 discloses a technology related to a server that selects an appropriate vehicle in response to a vehicle request from a vehicle request device, and that determines a route to a boarding location for the vehicle.

### CITATION LIST

### Patent Document

Patent document 1: Japanese Patent Laid-Open 2018-032427

The present disclosure has its object to provide an information processing apparatus, a wireless communication terminal, and an information processing method that are capable of facilitating meeting up of users of wireless communication terminals, for whom a meet-up schedule is set.

### SUMMARY

One aspect of the present, disclosure is an information processing apparatus including
a controller configured to;
notify, when a meet-up schedule is set between users of a first wireless communication terminal and a second wireless communication terminal that are capable of communicating with the information processing apparatus through a communication network by a first wireless communication scheme, the second wireless communication terminal of identification information of the first wireless communication terminal indicating a source of a signal in a second wireless communication scheme different from the first wireless communication scheme, through the communication network by the first wireless communication scheme.

Another aspect of the present disclosure is a wireless communication terminal including:
a first communicator compatible with a first wireless communication scheme;
a second communicator compatible with a second wireless communication scheme different from the first wireless communication scheme; and
a controller configured to:
   operate as a transmitter configured to transmit, every predetermined period, a first wireless signal according to the second wireless communication scheme, the first wireless signal including identification information indicating a source of a wireless signal in the second wireless communication scheme, the identification information being of the wireless communication terminal and already notified, by an information processing apparatus capable of performing communication through a communication network by the first wireless communication scheme, to another wireless communication terminal of a user for whom a meet-up schedule with a user of the wireless communication terminal is set by the information processing apparatus; or
   operate as a receiver of the wireless signal according to the second wireless communication scheme, and to detect presence of the other wireless communication terminal by receiving a second wireless signal including identification information of the other wireless communication terminal indicating a source of a wireless signal by the second wireless communication scheme, received from the information processing apparatus.

Another aspect of the present disclosure is an information processing method including:
notifying, by an information processing apparatus, when a meet-up schedule is set between users of a first wireless communication terminal and a second wireless communication terminal that are capable of communicating with the information processing apparatus through a communication network by a first wireless communication scheme, the second wireless communication terminal of identification information of the first wireless communication terminal indicating a source of a wireless signal in a second wireless communication scheme different from the first wireless communication scheme, through the communication network by the first wireless communications scheme;
implementing, by the first wireless communication terminal, operation of a transmitter of a first wireless signal according to the second wireless communication scheme, including the identification information of the first wireless communication terminal; and
implementing, by the second wireless communication terminal, operation of a receiver of a wireless signal according to the second wireless communication scheme; and
detecting, by the second wireless communication terminal, presence of the first wireless communication terminal by receiving the first wireless signal according to the second wireless communication scheme, including the identification information of the first wireless communication terminal.

According to the present disclosure, meeting up of users of wireless communication terminals, for whom a meet-up schedule is set, may be facilitated.

### BRIEF DESCRIPTION OF DRAWINGS

FIG. 1 is a diagram illustrating an example of a system configuration of a ride-sharing service providing system according to a first embodiment;

FIG. 2 is a diagram illustrating an example of respective hardware configuration of the in-vehicle device, the user terminal, and the center server;

FIG. 3 is a diagram illustrating an example of a functional configuration of the center server;

FIG. 4 illustrates an example of a reservation information table;

FIG. 5 is a diagram illustrating an example of a functional configuration of the in-vehicle device and the user terminal;

FIG. 6 is an example of a flowchart of the meet-up supporting process by the center server;

FIGS. 7A and 7B are examples of a flowchart of the communication monitoring process by the in-vehicle device or the user terminal;

FIG. 8 is a diagram illustrating a specific example of a sequence of processes by the ride-sharing service providing system according to the first embodiment;

FIG. 9 is a diagram illustrating a specific example of a sequence of processes by the ride-sharing service providing system according to the example modification.

### DESCRIPTION OF THE EMBODIMENTS

Hereinafter, an embodiment of the present disclosure will be described with reference to the drawings. The configuration of the following embodiment is merely an example, and the present disclosure is not limited to the configuration of the embodiment.

An aspect of the present disclosure is an information processing apparatus including a control unit. In the case where a meet-up schedule is set between users of a first wireless communication terminal and a second wireless communication terminal, the control unit of the information processing apparatus performs notification of identification information of the first wireless communication terminal indicating a source of a signal in a second wireless communication scheme, to the second wireless communication terminal through a communication network, by a first wireless communication scheme. The first wireless communication terminal and the second wireless communication terminal are capable of communicating with the information processing apparatus through the communication network by the first wireless communication scheme. The second wireless communication scheme is different from the first wireless communication scheme.

Another aspect of the present disclosure is a wireless communication terminal including a first communication unit compatible with the first wireless communication scheme, a second communication unit compatible with the second wireless communication scheme different from the first wireless communication scheme, and a control unit. The control unit of the wireless communication terminal operates as a transmitter that transmits a first wireless signal according to the second wireless communication scheme every predetermined period. The first wireless signal includes identification information of the wireless communication terminal for the second wireless communication scheme. The identification information of the wireless communication terminal for the second wireless communication scheme is identification information indicating a source of a wireless signal in the second wireless communication scheme. Moreover, the identification information of the wireless communication terminal for the second wireless communication scheme is already notified by the information processing apparatus, capable of communication through the communication network by the first wireless communication scheme, to another wireless communication terminal of a user for whom a meet-up schedule is set with a user of the aforementioned wireless communication terminal by the information processing apparatus.

The control unit of the wireless communication terminal also operates as a receiver of a wireless signal according to the second wireless communication scheme. In this case, the control unit of the wireless communication terminal detects presence of another wireless communication terminal by receiving a second wireless signal including identification information of the other wireless communication terminal. The identification information of the other wireless communication terminal indicates a source of a wireless signal in the second wireless communication scheme, and is received from the information processing apparatus.

For example, the first wireless communication terminal and the second wireless communication terminal, according to an aspect of the present disclosure are each assumed to be a wireless communication terminal of another aspect of the present disclosure. For example, the first wireless communication terminal operates as a transmitter that transmits a first wireless signal according to the second wireless communication scheme every predetermined period. For example, the second wireless communication terminal operates as a receiver of a wireless signal according to the second wireless communication scheme. In this case, the identification information of the first wireless communication terminal used for the second wireless communication scheme is notified by the information processing apparatus to the second wireless communication terminal by the first wireless communication scheme, and the second wireless communication terminal detects presence of the first wireless communication terminal by receiving a first wireless signal transmitted by the first wireless communication terminal.

According to an aspect of the present disclosure, a user of the second wireless communication terminal may recognize that a user of the first wireless communication terminal is present within a reachable range of the wireless signal. Accordingly, the user of the second wireless communication terminal may recognize that, the user of the first wireless communication terminal is present nearby, and is enabled to easily find the user of the first wireless communication terminal. Accordingly, the information processing apparatus according to an aspect of the present disclosure may support meeting up of the users of the first wireless communication terminal and the second wireless communication terminal, and meeting up of the first wireless communication terminal and the second wireless communication terminal is facilitated.

According to an aspect of the present disclosure, the first wireless communication scheme may be a communication scheme enabling the information processing apparatus to communicate with the first wireless communication terminal and the second wireless communication terminal through a predetermined relay apparatus, and the second wireless communication scheme may be a communication scheme enabling direct communication between the first wireless communication terminal and the second wireless communication terminal without use of the predetermined relay apparatus. In many cases, a communication range of the second wireless communication scheme is narrower than a communication range of the first wireless communication scheme. Accordingly, in the case of receiving a wireless signal according to the second wireless communication scheme, transmitted by the first wireless communication terminal, the second wireless communication terminal may detect that the first wireless communication terminal is present relatively nearby. Meeting up of users of the first wireless communication terminal and the second wireless communication terminal is thereby facilitated.

According to an aspect of the present disclosure, in a case where a first condition is satisfied, the control unit of the information processing apparatus may perform notification, to the second wireless communication terminal, of identification information of the first wireless communication terminal used for communication by the second wireless communication scheme. This allows notification, to the second wireless communication terminal, of the identification information of the first wireless communication terminal used for communication by the second wireless communication scheme to be performed only when the first condition is satisfied, and information of the first wireless communication terminal may be prevented from being needlessly notified to other wireless communication terminals.

According to an aspect of the present disclosure, in a case where a second condition is satisfied, the first wireless communication terminal may operate as a transmitter that transmits a first wireless signal according to the second wireless communication scheme every predetermined period. In this case, the control unit of the information processing apparatus may, in a case where a first condition is satisfied, perform notification to the second wireless communication terminal of an execution start timing of operation as the receiver of the wireless signal.

According to an aspect of the present disclosure, in a case where a second condition is satisfied, the second wireless communication terminal may operate as the receiver of a wireless signal according to the second wireless communication scheme, and may detect presence of the first wireless communication terminal by receiving the first wireless signal according to the second wireless communication scheme, including the identification information of the first wireless communication terminal. In this case, the control unit of the information processing apparatus may, in a case where a first condition is satisfied, perform notification to the first, wireless communication terminal of an execution start timing of operation as the transmitter of the wireless signal according to the second wireless communication scheme, the wireless signal including the identification information of the first wireless communication terminal.

The first condition may be determination, by the control unit of the information processing apparatus, of at least one of interruption of communication, through the communication network by the first wireless communication scheme, between the information processing apparatus and the first wireless communication terminal or the second wireless communication terminal, failing, to below a predetermined distance, of a distance between a scheduled meet-up location of the meet-up schedule and one of the first wireless communication terminal or the second wireless communication terminal, for which communication with the information processing apparatus through the communication network by the first wireless communication scheme is maintained, and arrival of a time point that is a predetermined time before a scheduled meet-up time point of to the meet-up schedule. The second condition may be determination, by the first wireless communication terminal or the second wireless communication terminal, of at least one of interruption of communication with the information processing apparatus through the communication network by the first wireless communication scheme, falling of a distance to the scheduled meet-up location of the meet-up schedule to below a predetermined distance, and arrival of the time point that is the predetermined time before the scheduled meet-up time point of the meet-up schedule.

According to an aspect of the present disclosure, by setting the first condition and the second condition in the manner described above, a duration when the first wireless communication terminal and the second wireless communication terminal operate as the transmitter or the receiver for the second wireless communication scheme may be limited, and power consumption of the two terminals may be reduced.

For example, in the case where the first condition at least includes determination, by the control unit, of the information processing apparatus, of interruption of communication, through the communication network according to the first wireless communication scheme, between the information processing apparatus and the first wireless communication terminal or the second wireless communication terminal, and the second condition at least includes determination, by the first wireless communication terminal or the second wireless communication terminal, of interruption of communication with the information processing apparatus through the communication network by the first wireless communication scheme, transmission and reception of the first wireless signal according to the second wireless communication scheme are performed between the first wireless communication terminal and the second wireless communication terminal even if communication between one of the terminals and the information processing apparatus according to the first wireless communication scheme is interrupted. Accordingly, for example, even if communication between one of the first wireless communication terminal or the second wireless communication terminal and the information processing apparatus according to the first wireless communication scheme is interrupted, possibility of the two terminals meeting up with each other may be increased.

Another aspect of the present disclosure is an information processing method including notifying, by an information processing apparatus, in a case where a meet-up schedule is set between users of a first wireless communication terminal and a second wireless communication terminal that are capable of performing communication through a communication network by a first wireless communication scheme, the second wireless communication terminal of identification information of the first wireless communication terminal indicating a source of a wireless signal according to a second wireless communication scheme different from the first wireless communication scheme, through the communication network by the first wireless communication scheme, implementing, by the first wireless communication terminal, operation of a transmitter of a first wireless signal according to the second wireless communication scheme, including the identification information of the first wireless communication terminal, and implementing, by the second wireless communication terminal, operation of a receiver of a wireless signal according to the second wireless communication scheme, and detecting, by the second wireless communication terminal, presence of the first wireless communication terminal by receiving the first wireless signal according to the second wireless communication scheme, including the identification information of the first wireless communication terminal.

### First Embodiment

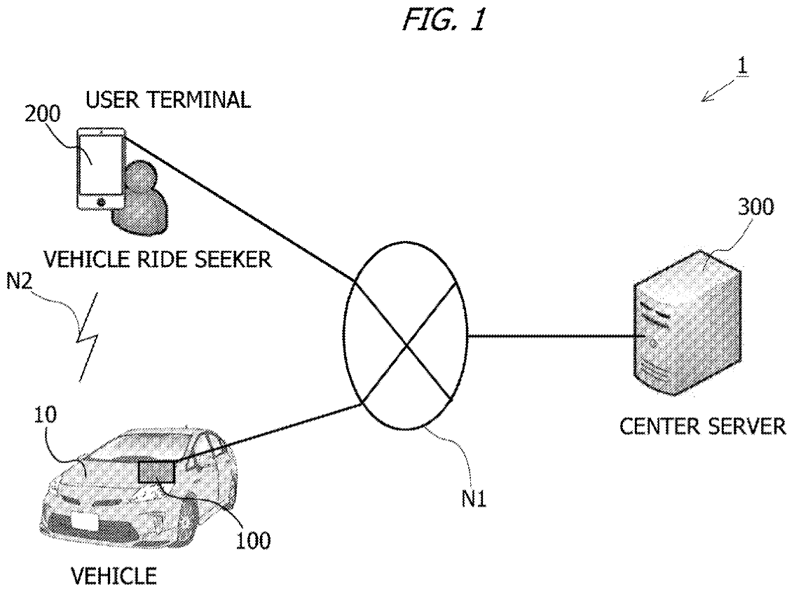

FIG. 1 is a diagram illustrating an example of a system configuration of a ride-sharing service providing system 1 according to a first embodiment. The ride-sharing service providing system 1 is a system that provides a service of joining a driver wishing to share ride on a vehicle and a vehicle ride seeker wishing to ride in a vehicle, based on destinations, desired traveling times and the like of the two parties, for example, and of providing the vehicle ride seeker with means of transport and the driver with an incentive. Joining of a driver wishing to share a ride on a vehicle and a vehicle ride seeker wishing to ride in a vehicle in such a way that their respective conditions are satisfied will be referred to below as “matching”.

The ride-sharing service providing system 1 includes vehicles 10 to be driven by a plurality of drivers, user terminals 200 of a plurality of vehicle ride seekers, and a center server 300. FIG. 1 extracts and illustrates one each of the vehicles 10 and the user terminals 200. The vehicle 10 is equipped with an in-vehicle device 100. The in-vehicle device 100, the user terminal 200, and the center server 300 are connected to a network N1. The network N1 is a public communication network such as the Internet, for example. The in-vehicle device 100 and the user terminal 200 are capable of communicating with the center server 300 through the network N1. The in-vehicle device 100 and the user terminal 200 are capable of directly communicating with each other without using a relay apparatus such as the center server 300, a base station, an access point, or a router.

The center server 300 is an example of “information processing apparatus”. The in-vehicle device 100 and the user terminal 200 are examples of “wireless communication terminal”. The network. N1 is an example of “communication network according to a first, wireless communication scheme”.

An application for receiving a ride-sharing service is installed in the user terminal 200 of the vehicle ride seeker, for example. The vehicle ride seeker transmits information about the vehicle ride seeker and a ride request to the center server 300 by activating the application on the user terminal 200 and operating the application, for example. A boarding location, an alighting location, a desired traveling time and the like are also transmitted together with the ride request, for example.

An application for receiving the ride-sharing service is also installed in the in-vehicle device 100, for example. The driver transmits information about the driver and the vehicle 10 to the center server 300 by activating the application on the in-vehicle device 100 and operating the application.

The center server 300 receives registration of information from the in-vehicle device 100 and the user terminal 200 registered for the ride-sharing service, for example. Identification information of the vehicle ride seeker and the driver is registered in the center server 300, for example.

The center server 300 receives, from the user terminal 200 of the vehicle ride seeker, a ride reservation request requesting for a reservation of a ride in the vehicle 10 by ride-sharing. When the ride reservation request is received, the center server 300 performs matching of the vehicle ride seeker and a driver Any known technique may be used as the method of matching For example, the center server 300 selects a matching counterpart of the vehicle ride seeker from drivers whose planned traveling routes contain at least one of a boarding location and an alighting location of the vehicle ride seeker, and whose scheduled traveling times on the planned traveling routes contain a desired traveling time of the vehicle ride seeker.

When matching is complete, the center server 300 transmits the ride reservation request to the in-vehicle device 100 that is associated with the matched driver. A scheduled meet-up location and a scheduled meet-up time for the vehicle ride seeker, a desired alighting location of the vehicle ride seeker, information about the vehicle ride seeker, and the like are also transmitted to the in-vehicle device 100, together with the ride reservation request. The scheduled meet-up location, the scheduled meet-up time, and the like are calculated by the center server 300, for example. When an OK response for the ride reservation request is returned from the in-vehicle device 100, the center server 300 determines reservation establishment for the ride reservation request from the user terminal 200 of the vehicle ride seeker, and transmits a ride reservation establishment notification to the user terminal 200. The state that a ride reservation is established means that “meet-up schedule is set”, for example.

For example, when a time point that is a predetermined time before a meet-up time point of the ride reservation arrives, the in-vehicle device 100 and the user terminal 200 each start transmission of position information to the center server 300, which is to be performed every predetermined period. For example, the center server 300 monitors positions of the in-vehicle device 100 and the user terminal 200 based on the position information received from the in-vehicle device 100 and the user terminal 200. For example, when detecting entering of the in-vehicle device 100 and the user terminal 200 into a predetermined range of the scheduled meet-up location, the center server 300 transmits, to the in-vehicle device 100 and the user terminal 200, approach notifications regarding the counterparts to thereby support meeting up of the driver and vehicle ride seeker.

On the other hand, in the case where the user terminal 200 includes a communication unit compatible with WiFi, and is connected to the network N1 through a wireless LAN network, the vehicle ride seeker possibly moves out of a communication range of an access point of the wireless LAN when moving. If the user terminal 200 does not include a communication unit which can be connected to the network N1, other than the communication unit compatible with WiFi, the user terminal 200 is disabled from connecting to the network N1, and communication with the center server 300 is interrupted. A communication unit which can be connected to the network N1 may be a communication unit, that is compatible with a wireless communication scheme of connecting to a carrier network such as Long Term Evolution (LTE) or WIMAX, for example, instead of the communication unit compatible with WiFi. The wireless communication scheme such as WiFi, LTE, 3G, or WIMAX, which enables connection to the network N1 is an example of “first wireless communication scheme”.

When connection to the network N1 is disabled, the vehicle ride seeker is prevented from receiving the approach notification regarding the driver from the center server 300, or from talking through a user terminal of the driver using an application such as Internet calling, for example, and meeting up with the driver becomes difficult.

A similar problem arises also in the case where the user terminal 200 does not include a communication unit other than a communication unit which is compatible with a wireless communication scheme of s carrier network such as LTE, and when the user terminal 200 moves out of the communication range of the carrier network, and also in the case where the in-vehicle device 100 does not include a communication unit other than a communication unit which is compatible with a wireless communication scheme of a carrier network such as LTE, and when the in-vehicle device 100 moves out of the communication range of the carrier network, without being limited to the user terminal 200.

In the first embodiment, it is assumed that the user terminal 200 of the vehicle ride seeker includes a communication unit which is compatible with WiFi, and does not include a communication unit which can be connected to the network N1, other than the aforementioned communication unit. On the other hand, the in-vehicle device 100 is assumed to include a communication unit which connects to a carrier network such as LTE, and to connect to the network N1 through the carrier network. Generally, with WiFi, installation of access points is limited to a predetermined area depending on a provider, for example, and a communication area covered by one provider is narrower compared to the carrier network. Accordingly, in the case of connecting to the network N1 using WiFi, connection with the network N1 is more likely to be interrupted compared to a case of connecting to the network N1 using the carrier network.

Accordingly, in the first embodiment, even if the user terminal 200 and the in-vehicle device 100 are present at a same location, a situation possibly occurs where the user terminal 200 of the vehicle ride seeker is not able to connect to the network N1, while the in-vehicle device 100 is able to connect to the network N1. In the first embodiment, in the case where the user terminal 200 and the in-vehicle device 100 are present at a same location, a situation possibly occurs where neither the user terminal 200 of the vehicle ride seeker nor the in-vehicle device 100 is able to connect to the network N1. Furthermore, in the first embodiment, a situation possibly occurs where the in-vehicle device 100 is net able to connect to the network N1, while the user terminal 200 of the vehicle ride seeker is able to connect to the network N1.

In the first embodiment, the in-vehicle device 100 and the user terminal 200 each include a communication unit which is compatible with near field communication such as Bluetooth (registered trademark). The communication unit which is compatible with near field communication is a communication unit which does not include a function of connecting to the network N1, but includes a function enabling direct communication with a counterpart device within a communicable range. Near field communication such as Bluetooth (registered trademark) is an example of “second wireless communication scheme”.

In the first embodiment, in the case where a ride reservation is established between the in-vehicle device 100 and the user terminal 200, and connection between one of the in-vehicle device 100 or the user terminal 200 and the network N1 is interrupted, one of the in-vehicle device 100 or the user terminal 200 starts to operate as a transmitter for near field communication, and the other starts to operate as a receiver for near field communication, and presence of the counterparts is recognized by transmission/reception of wireless signals. In the first embodiment, the center server 300 monitors communication of the in-vehicle device 100 and the user terminal 200, and supports start of near field communication by the two parties in a case of interruption of connection between one of the parties and the network N1.

For example, in the case where connection between the user terminal 200 of the vehicle ride seeker and the network N1 is interrupted, and such a circumstance is detected, the user terminal 200 starts to operate as a transmitter of signals of near field communication such as Bluetooth (registered trademark). A signal that is transmitted by the user terminal 200 includes identification information of the user terminal 200 for near field communication, for example. The identification information of the user terminal 200 for near field communication is an example of “identification information” “indicating a source of a signal according to a second wireless communication scheme”.

The center server 300 detects interruption of connection between the user terminal 200 and the network N1 by interruption of communication with the user terminal 200, for example. The center server 300 transmits to the in-vehicle device 100, through the network N1, a notification regarding interruption of communication with the user terminal 200 and the identification information of the user terminal 200 for near field communication, and causes the in-vehicle device 100 to start operating as a receiver for near field communication such as Bluetooth (registered trademark). When a signal including the identification information of the user terminal 200 for near field communication is received in near field communication, the in-vehicle device 100 displays an approach notification regarding the vehicle ride seeker on a display device, for example, and notifies the driver of approach of the vehicle ride seeker.

Accordingly, for example, even in a situation where the user terminal 200 is not able to connect to the network N1, the in-vehicle device 100 may detect approach of the user terminal 200 by using near field communication, and the driver may be supported to find the vehicle ride seeker. Additionally, in the first, embodiment, in the case where connection between the in-vehicle device 100 and the network N1 is interrupted, the operation of the user terminal 200 and the operation of the in-vehicle device 100 are switched. Specifically, in the case where connection between the in-vehicle device 100 and the network N1 is interrupted, the in-vehicle device 100 operates as the transmitter for near field communication. The user terminal 200 receives identification information of the in-vehicle device 100 for near field communication from the center server 300, and operates as the receiver for near field communication, and when a signal from the in-vehicle device 100 is received, an approach notification regarding the driver is displayed. Accordingly, the in-vehicle device 100 and the user terminal 200 are both an example of “first wireless communication terminal” and “second wireless communication terminal”.

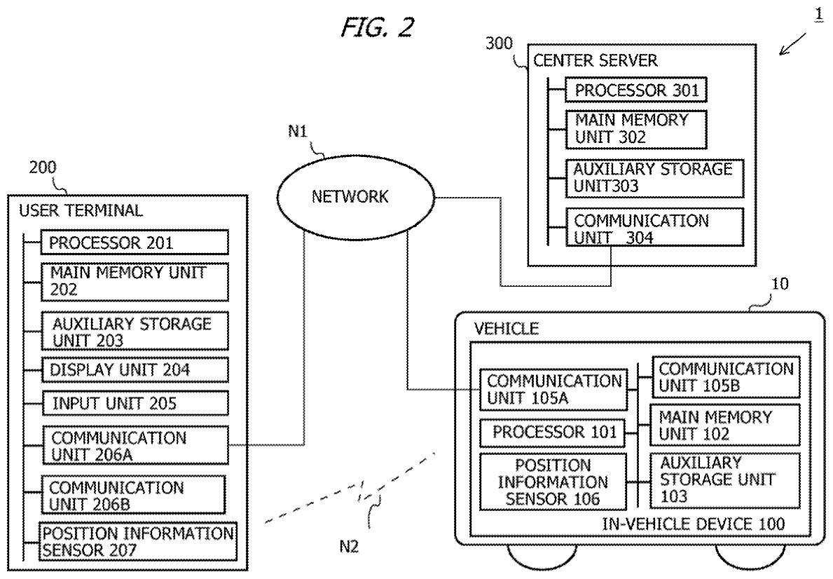

FIG. 2 is a diagram illustrating an example of respective hardware configuration of the in-vehicle device 100, the user terminal 200, and the center server 300. For example, the center server 300 is a general-purpose or dedicated computer. The center server 300 includes, as hardware components, a processor 301, a main memory unit 302, an auxiliary storage unit 303, and a communication unit 304. These are interconnected by a bus.

The processor 301 is a central processing unit (CPU), for example. The processor 301 executes a computer program that is loaded into the main memory unit 302 in an executable manner, and performs processing as the center server 300. The processor 301 provided in the center server 300 is not limited to a single processor, and may adopt a multi-processor configuration. Alternatively, a single CPU connected by a single socket may have a multicore configuration. At least a part, of processes by the center server 300 may be performed by a processor other than the CPU, such as a dedicated processor such as a digital signal processor (DSP) or a graphics processing unit (GPU). At least a part of processes by the center server 300 may be performed by an integrated circuit (IC), another digital circuit, or another analog circuit. The processor 301 is an example of “controller” of “information processing apparatus”.

The main memory unit 302 stores computer programs to be executed by the processor 301, data to be processed by the processor 301, and the like. For example, the main memory unit. 302 is a dynamic random access memory (DRAM), a static random access memory (SRAM), or a read only memory (ROM). The auxiliary storage unit 303 is a non-volatile memory, and is a hard disk drive, a solid state drive (SSD), or the like. The auxiliary storage unit 303 stores computer programs which are yet to be loaded into the main memory unit 302, various pieces of data, and the like. Programs which are stored in the auxiliary storage unit 303 include an operation system (OS), a ride-sharing control program, and the like, for example. The ride-sharing control program is a program for causing a computer to perform the processing of the center server 300 in the ride-sharing service providing system 1.

For example, the communication unit 304 connects to the network N1 through a local area network (LAN), and communicates with the in-vehicle device 100, the user terminal 200 and the like through the network N1.

The hardware configuration of the center server 300 is not limited to the configuration illustrated in FIG. 2. For example, the center server 300 is capable of reading a program recorded in a removable recording medium, of loading the program into the main memory unit 302, and of executing the program. For example, the removable recording medium is a universal serial bus (USB) memory, or a disk recording medium such as a compact disc (CD), a digital versatile disc (DVD) or a Blu-ray disc.

For example, the user terminal 200 is a small computer such as a smartphone, a mobile phone terminal, a tablet terminal, a personal digital assistant, or a wearable computer (such as a smartwatch), The user terminal 200 may be a personal computer (PC). A description is given with reference to FIG. 2, assuming that the user terminal 200 is a smartphone.

The user terminal 200 includes a processor 201, a main memory unit 202, an auxiliary storage unit 203, a display unit 204, an input unit 205, a communication unit 206A, a communication unit 206B, and a position information sensor 207. Descriptions of the processor 201, the main memory unit 202, and the auxiliary storage unit 203 are the same as the descriptions of the processor 301, the main memory unit 302, and the auxiliary storage unit 303 of the center server 300, and descriptions thereof are omitted. Note that an application program for receiving the ride-sharing service is stored in the auxiliary storage unit 203 of the user terminal 200. The processor 201 is an example of “controller” of “wireless communication terminal”.

For example, the display unit 204 is a liquid crystal display (LCD) or an electroluminescence (EL) panel. The input unit 205 includes a touch panel, a push button, and the like. The input unit 205 further includes a camera to enable input of videos and images. The input unit 205 may further include an input unit for audio, such as a microphone.

The communication unit 206A is a communication unit, which is compatible with WiFi, for example. The communication unit 206A accesses the network N1 using WiFi, and performs communication with the center server 300 and the like, for example. The communication unit 206A may be a communication unit which is compatible with a communication scheme adopted by a carrier network such as LTE, LTE-Advanced, or 3G, for example. WiFi, LTE, LTE-Advanced, 3G, and the like are each an example of “first wireless communication scheme”. The communication unit 206A is an example of “first communicator”.

The communication unit 206B is a communication unit, which is compatible with Bluetooth (registered trademark), for example. The communication unit 206B performs direct wireless communication with a counterpart device without using a predetermined relay apparatus. A predetermined relay apparatus is an access point, a base station, or a router, for example. The communication unit 206B may be a communication unit which is compatible with WiFi-Direct/Bluetooth Low Energy (BLE), or the like. A wireless communication scheme for near field communication such as Bluetooth (registered trademark), WiFi-Direct, or Bluetooth Low Energy (BLE) is an example of “second wireless communication scheme”. The communication unit 206B is an example of “second communicator”. The access point, the base station, a router, and the like are examples of “predetermined relay apparatus”.

The position information sensor 207 acquires position information of the user terminal 200 every predetermined period. For example, the position information sensor 207 is a global positioning system (GPS) receiver, a WiFi communication unit, or the like. The hardware configuration of the user terminal 200 is not limited to the configuration illustrated in FIG. 2.

The in-vehicle device 100 includes a processor 101, a main memory unit 102, an auxiliary storage unit 103, a display unit 104, a communication unit 105A, a communication unit 105B, and a position information sensor 106. Descriptions of the processor 101, the main memory unit 102, the auxiliary storage unit 103, the display unit 104, the communication unit 105A, the communication unit 105B, and the position information sensor 106 are the same as the descriptions of the processor 301, the main memory unit 302, the auxiliary storage unit 303, the display unit 204, the communication unit 206A, the communication unit 206B, and the position information sensor 207, and are thus omitted. Note that an application program for receiving the ride-sharing service is stored in the auxiliary storage unit 103 of the in-vehicle device 100. The processor 101 is an example of “controller” of “wireless communication terminal”. The communication unit 105A is an example of “first communicator”. The communication unit 105B is an example of “second communicator”.

The network N1 is a worldwide public communication network such as the Internet, but a wide area network (WAN) or other communication networks may also be adopted, for example. The network N1 may include telephone communication network for mobile phones, and a wireless communication network such as WiFi.

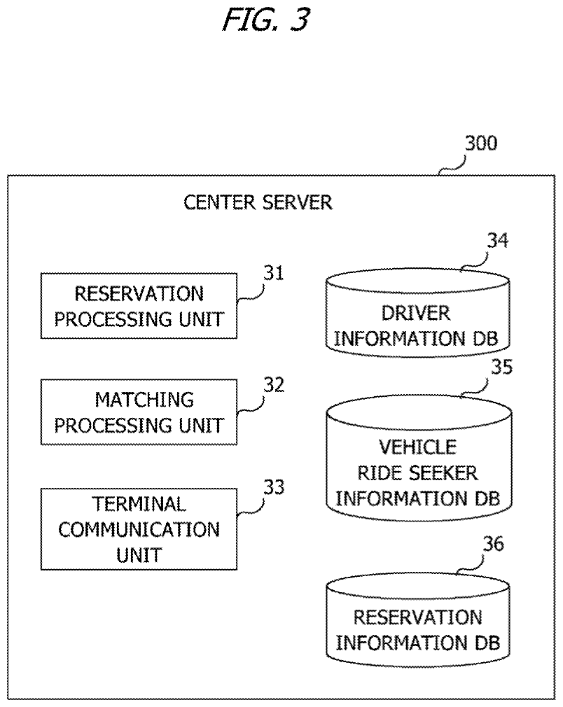

FIG. 3 is a diagram illustrating an example of a functional configuration of the center server 300. As functional components, the center server 300 includes a reservation processing unit 31, a matching processing unit 32, a terminal, communication unit 33, a driver information database (DB) 34, a vehicle ride seeker information DB 35, and a reservation information DB 36. These functional components are functional components that are achieved by the processor 301 of the center server 300 executing the ride-sharing control program that is stored in the auxiliary storage unit 303, for example. However, any of the functional components, or a part of processes thereof may be executed by a hardware circuit.

The terminal communication unit 33 is an interface to the in-vehicle device 100 and the user terminal 200. The terminal communication unit 33 performs transmission/reception of data with the in-vehicle device 100 and the user terminal 200 through the communication unit 304. Specifically, the terminal communication unit 33 receives a ride reservation request from the user terminal 200, and outputs the ride reservation request to the reservation processing unit 31, for example. The terminal communication unit 33 receives position information from the in-vehicle device 100 and the user terminal 200, outputs the position information to the reservation processing unit 31, for example.

The reservation processing unit 31 performs control regarding ride reservation. Specifically, the reservation processing unit 31 receives a ride reservation request from the user terminal 200 through the terminal communication unit 33. A desired hoarding location, a desired alighting location, a desired traveling time, and near field communication information of the user terminal 200 are also received from the user terminal 200, together with the ride reservation request. The near field communication information is identification information of the user terminal 200 used for near field communication, for example. In the case where the user terminal 200 uses Bluetooth for near field communication, the near field communication information is an ID included in a beacon, for example. The near field communication information is an example of “identification information indicating a source of a wireless signal according to the second wireless communication scheme”.

In the case where the ride reservation request is received from the user terminal 200, the reservation processing unit 31 requests the matching processing unit 32 for matching. The reservation processing unit 31 receives, from the matching processing unit 32, input of information about a driver matched with the vehicle ride seeker of the user terminal 200, a scheduled meet-up location, and a scheduled meet-up time. The reservation processing unit 31 transmits, through the terminal communication unit 33, the ride reservation request to the in-vehicle device 100 corresponding to the driver matched with the vehicle ride seeker of the user terminal 200. Ride reservation information is also transmitted together with the ride reservation request. For example, the ride reservation information includes the scheduled meet-up location and the scheduled meet-up time, a desired alighting location and a desired arrival time of the vehicle ride seeker, and information about the vehicle ride seeker. The information about the vehicle ride seeker included in the ride reservation information includes a user ID, attribute and the like of the vehicle ride seeker, for example.

In the case where an OK response for the ride reservation request is received from the in-vehicle device 100 through the terminal communication unit 33, the reservation processing unit 31 determines that the ride reservation is established, and registers the ride reservation information in the reservation information DB 36. Additionally, near field communication information of the in-vehicle device 100 is also received together with the OK response for the ride reservation request, for example.

The reservation processing unit 31 transmits a ride reservation establishment notification to the user terminal 200, which is a source of the ride reservation request, through the terminal communication unit 33. For example, the scheduled meet-up location, the scheduled meet-up time, and the information about the driver are also transmitted together with the ride reservation establishment notification. The information about the driver includes a user ID and an attribute of the driver, and information about the vehicle 10, for example.

For example, when a time point that is a predetermined time before the scheduled meet-up time of the ride reservation arrives, the reservation processing unit 31 starts a meet-up supporting process. The meet-up supporting process is a process for supporting meeting up of the driver and the vehicle ride seeker between whom the ride reservation is established. A time point when the meet-up supporting process is started is a time point such as 10 minutes, 15 minutes or 30 minutes before the scheduled meet-up time of the ride reservation, for example. A start timing of the meet-up supporting process may be set by any of an administrator of the ride-sharing service providing system 1, the vehicle ride seeker, or the driver, for example. Specifically, the meet-up supporting process is as follows.

The reservation processing unit 31 receives, every predetermined period, position information of each of the in-vehicle device 100 and the user terminal 200 between which the ride reservation is established, and grasps the position information of the two parties. The reservation processing unit 31 also monitors states of communication with the two parties. When interruption of communication with the two parties is not detected, and, for example, when entering of the two parties into a predetermined range of the scheduled meet-up location is detected, the reservation processing unit 31 transmits an approach notification to the two parties.

On the other hand, if interruption of communication between one of the in-vehicle device 100 or the user terminal 200 and the network N1 is detected, the reservation processing unit 31 transmits, to the other party for which communication is not interrupted, a whereabouts unknown notification and the near field communication information about the one with respect to which interruption of communication is detected. The in-vehicle device 100 or the user terminal 200 which received the whereabouts unknown notification starts to operate as the receiver for near field communication. The whereabouts unknown notification is an example of “notification” of “execution start timing”.

The matching processing unit 32 performs, in response to a request from the reservation processing unit 31, matching of the vehicle ride seeker of the user terminal 200 which is the source of the ride reservation request, and a driver. A matching method adopted by the matching processing unit 32 may be any of known techniques, and is not limited to a specific method. For example, the matching processing unit 32 extracts, from the driver information DS 34 described later, a driver whose scheduled traveling time contains the desired traveling time in the ride reservation request, and whose travel plan contains, near a destination or a via point and in vicinities thereof, the desired boarding location and the desired alighting location of the vehicle ride seeker. The matching processing unit 32 selects, from extracted drivers, a matching counterpart of the vehicle ride seeker, randomly or based on an evaluation value, the attribute or the like, for example.

The matching processing unit 32 also determines the scheduled meet-up location based on the desired boarding location and the desired alighting location of the vehicle ride seeker and the destination and the via point of the driver. The matching processing unit 32 further determines the scheduled meet-up time based on the desired traveling time of the vehicle ride seeker and the scheduled traveling time of the driver. Methods of determining the scheduled meet-up location and the scheduled meet-up time may be any of known techniques, and are not limited to specific methods. The matching processing unit 32 outputs, to the reservation processing unit 31, information about the selected driver, the scheduled meet-up location, the scheduled meet-up time, and the like.

The driver information DB 34, the vehicle ride seeker information DB 35, and the reservation information DB 36 are each constructed by management of data, stored in the auxiliary storage unit 303, by a program in a database management system (DBMS) executed by the processor 301, for example. The driver information DB 34 the vehicle ride seeker information DB 35, and the reservation information DB 36 are relational databases, for example.

The driver information DB 34 includes information about a driver. Information about a driver includes a user ID of the driver, an in-vehicle device ID attribute information of the driver, contact information of the driver, a vehicle ID, external appearance information of the vehicle, a maximum number of passengers of the vehicle, and information about a travel plan of the driver, for example. Attributes of the driver include information about gender, age, and a resident district, for example. The external appearance information of the vehicle includes information about a model and a color of the vehicle, and a license number, for example. The information about a travel plan of the driver includes information about the scheduled traveling time, a departure point, a destination, a via point, and the like.

The information stored in the driver information DB 34 is information that is registered by a driver through the in-vehicle device 100 or the like, for example. The information about a driver stored in the driver information DB 34 is used by the matching processing unit 32 at the time of matching, for example. The information about a driver who is selected as the matching counterpart of a vehicle ride seeker is read from the driver information DB 34, is notified to the reservation processing unit 31 by the matching processing unit 32, and is notified to the user terminal 200 together with the ride reservation establishment notification, for example. The information, about a driver who is selected as the matching counterpart of a vehicle ride seeker, which is notified to the user terminal 200 together with the ride reservation establishment notification may be all or a part of information about the driver that is held in the driver information DB 34, for example.

The vehicle ride seeker information DB 35 includes information about a vehicle ride seeker. Information about a vehicle ride seeker includes a user ID of the vehicle ride seeker, an ID of the user terminal 200, attribute information of the vehicle ride seeker, and contact information of the vehicle ride seeker, for example. Attributes of the vehicle ride seeker include information about gender, age, and a resident district, for example.

The information stored in the vehicle ride seeker information DB 35 is information registered by a vehicle ride seeker through the user terminal 200, for example. The information about a vehicle ride seeker stored in the vehicle ride seeker information DB 35 is used by the matching processing unit 32 at the time of matching, for example. The information about a vehicle ride seeker is read from the vehicle ride seeker information DB 35, is notified to the reservation processing unit 31 by the matching processing unit 32, and is notified to the in-vehicle device 100 together with the ride reservation request, for example. The information about a vehicle ride seeker which is notified to the in-vehicle device 100 together with the ride reservation request, for example, may be all or a part of information about the vehicle ride seeker held in the vehicle ride seeker information DB 35.

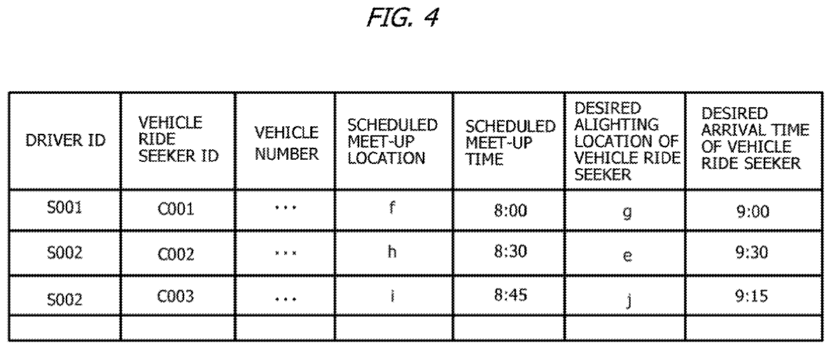

FIG. 4 illustrates an example of a reservation information table. The reservation information table is a table that is held in the reservation information DB 36. The reservation information table is a table that holds information about a ride reservation.

The reservation information table illustrated in FIG. 4 contains fields of a driver ID, a vehicle ride seeker ID, a vehicle number, a scheduled meet-up location a scheduled meet-up time, a desired alighting location of a vehicle ride seeker, and a desired arrival time of a vehicle ride seeker. An ID for identifying a driver is input in the driver ID field. An ID for identifying a vehicle ride seeker is input in the vehicle ride seeker ID field. Identification information for identifying the vehicle 10 is input in the vehicle number field.

Information about a scheduled meet-up location determined by the matching processing unit 32 is input in the scheduled meet-up location field. For example, any of longitude and latitude, an address, and a name of a landmark may be input in the scheduled meet-up location field as information about a scheduled meet-up location. A scheduled meet-up time determined by the matching processing unit 32 is input in the scheduled meet-up time field.

Information pieces to be stored in the fields of the desired alighting location and the desired arrival time of a vehicle ride seeker are input based on the desired alighting location and the scheduled traveling time which are received together with the ride reservation request from the user terminal 200 of the vehicle ride seeker.

A first entry in the example illustrated in FIG. 4 indicates that a vehicle ride seeker C001 is to meet up with the vehicle 10 which is driven by a driver S001 at a location f at 8:00, and that the driver S001 is to drive the vehicle 10 toward a destination g. A second and a third entries in the example illustrated in FIG. 4 indicates that a vehicle ride seeker C002 is to meet up with the vehicle 10 which is driven by a driver S002 at a location h at 8:30, and that the driver S002 is to drive the vehicle 10 toward a location i to further pick up a vehicle ride seeker C003 at the location i at 8:45. It is also indicated that the driver S002 is to drive the vehicle 10 toward a destination j of the vehicle ride seeker C003, to drop off the vehicle ride seeker C003 at the location j, and then, to drive the vehicle 10 toward a destination e of the vehicle ride seeker C002.

Additionally, one or some of the functional components of the center server 300, or a part of processes of the functional components may be implemented by another computer that is connected to the network N1. For example, processes by the reservation processing unit 31 and the matching processing unit 32 may be performed by separate computers.

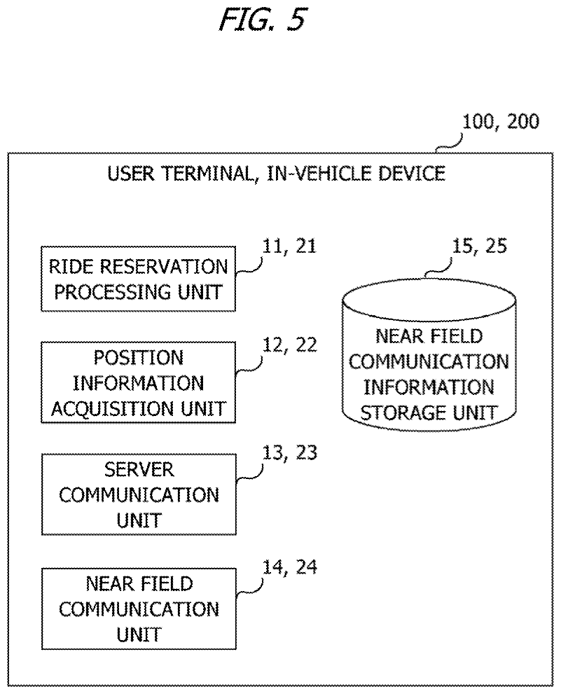

FIG. 5 is a diagram illustrating an example of a functional configuration of the in-vehicle device 100 and the user terminal 200. The in-vehicle device 100 and the user terminal 200 each include, as functional components, a ride reservation processing unit 11, 21, a position information acquisition unit 12, 22, a server communication unit 13, 23, a near field communication unit. 14, 24, and a near field communication information storage unit 15, 25. These functional components are functional components that are achieved by the processor 101 or 201 of the in-vehicle device 100 or the user terminal 200 executing the application program, for receiving the ride-sharing service, stored in the auxiliary storage unit 103 or 203. Additionally, any of the functional components, or a part of processes thereof may be executed by a hardware circuit.

The functional configuration is the same for the in-vehicle device 100 and the user terminal 200, and the user terminal 200 will be mainly described in the description of FIG. 5 given below. Same functional components of the in-vehicle device 100 and the user terminal 200 are assumed to perform same processes unless specified otherwise.

The server communication unit 23 is an interface to the center server 300. For example, the server communication unit 23 performs transmission/reception of data with the center server 300 through the communication unit 206A.

The near field communication unit 24 is an interface used at the time of performing near field communication with a device that is present in a communication range and that performs near field communication by a same near field communication scheme. For example, the near field communication unit 24 performs transmission/reception of data through the communication unit 206B.

The position information acquisition unit 22 acquires, every predetermined period, the position information of the user terminal 200 that is acquired by the position information sensor 207, for example. The position information of the user terminal 200 may be any of longitude and latitude, an address, and the like.

The ride reservation processing unit 21 performs control regarding the ride-sharing service. Specifically, the ride reservation processing unit 21 performs a registration process of information about a user in the center server 300, a process regarding a ride reservation, and a process regarding execution of the ride-sharing service, for example

In the registration process of information about a user in the center server 300, the ride reservation processing unit 21 transmits information about a user input by a user operation to the center server 300 through the server communication unit 23. Information about a user is a user ID, an attribute of the user, and the like. In the case where a user registers for the ride-sharing service as a driver, information about the vehicle 10 is also included in the information about the user, for example.

Next, with respect to the process regarding a ride reservation, the process by the ride reservation processing unit 21 differs between the user terminal 200 of a vehicle ride seeker and the in-vehicle device 100 of a driver.

When a ride reservation request, is input from the input unit 205 by a user operation, the ride reservation processing unit 21 of the user terminal 200 of a vehicle ride seeker transmits the ride reservation request to the center server 300 through the server communication unit 23. The user ID, the desired boarding location, the desired alighting location, the desired traveling time, the near field communication information of the user terminal 200, and the like are also transmitted to the center server 300, together with the ride reservation request, for example. The desired boarding location, the desired alighting location, and the desired traveling time are input to the user terminal 200 by the vehicle ride seeker, for example. The desired traveling time is defined by at least one of a desired boarding time or a desired arrival time at the desired alighting location, for example.

When a ride reservation establishment notification is received from the center server 300 through the server communication unit 23, the ride reservation processing unit 21 saves the ride reservation information in a predetermined memory area in the main memory unit 202, for example. The scheduled meet-up location, the scheduled meet-up time, and information about the driver are also received together with the ride reservation establishment notification, for example.

For its part, the ride reservation processing unit 11 of the in-vehicle device 100 of the driver receives the ride reservation request from the center server 300 through the server communication unit 13. The ride reservation information is also received together with the ride reservation request, for example. The ride reservation information includes the scheduled meet-up location and the scheduled meet-up time, the desired alighting location, the desired arrival time, and information about the vehicle ride seeker, for example. The ride reservation processing unit 11 notifies the driver of specifics of the ride reservation request by displaying the ride reservation information on the display unit, for example, and urges determination of whether or not to accept the ride reservation request.

For example, when acceptance of the ride reservation request is input by a user operation, the ride reservation processing unit 11 transmits an OK response to the center server 300 through the server communication unit 13. The near field communication information of the in-vehicle device 100 is also transmitted to the center server 300, together with the OK response. For example, when rejection of the ride reservation request is input by a user operation, the ride reservation processing unit 11 transmits an NG response to the center server 300 through the server communication unit 13.

In the process regarding execution of the ride-sharing service, the ride reservation processing unit 21 performs a communication monitoring process and a service completion process, for example. The communication monitoring process is a process of monitoring a state of connection to the network N1 until meeting up with a counterpart of a ride reservation is completed, and of securing communication with a terminal of the counterpart of the ride reservation by near field communication in a case where communication with the network N1 is interrupted. The service completion process is a process that is performed according to completion of a service for which a ride reservation was made.

In the communication monitoring process, the ride reservation processing unit 21 monitors a state of connection to the network N1. In the case where disconnection of connection to the network N1 is detected, the ride reservation processing unit 21 causes the near field communication unit 24 to start transmission of signals. The near field communication unit 24 starts transmission of signals from the communication unit 206B in response to the instruction from the ride reservation processing unit 21. The near field communication unit 24 includes the near field communication information of the user terminal 200 in the signal to be transmitted. For example, in the case where near field communication is Bluetooth, the signal that is transmitted from the communication unit 206B is a beacon signal. The beacon signal of Bluetooth is an example of “first wireless signal”. Additionally, “first wireless signal” is not limited to the beacon signal of Bluetooth.

The ride reservation processing unit 21 causes transmission of signals of near field communication to be started, in a case where it is detected that a starting condition for near field communication is satisfied. For example, the starting condition for near field communication is one or a combination of arrival of a time point that is a predetermined time before the scheduled meet-up time, entering of the user terminal 200 into a predetermined area including the scheduled meet-up location, and falling of a distance from the scheduled meet-up location to below a predetermined distance.

When the terminal of the counterpart of the ride reservation enters a reachable range of a signal including the near field communication information of the user terminal 200, the terminal of the counterpart receives the signal that is transmitted from the user terminal 200. For example, when a response is received from the terminal of the counterpart through the near field communication unit 24, the ride reservation processing unit 21 displays, on the display unit 204, an approach notification notifying of approach of the counterpart of the ride reservation. However, depending on the near field communication scheme, the terminal of the counterpart does not transmit a response even when a signal is received, and display of the approach notification is not performed in such a case.

Furthermore, in the communication monitoring process, a whereabouts unknown notification notifying of interruption of communication with the terminal of the counterpart of the ride reservation is possibly received from the center server 300. When the whereabouts unknown notification is received through the server communication unit 23, the ride reservation processing unit 21 instructs the near field communication unit 24 to start operating as the receiver for near field communication. The near field communication unit 24 causes the communication unit 206B to start operating as the receiver, in response to the instruction from the ride reservation processing unit 21. The operation of the receiver for near field communication is to intermittently activate a reception circuit for near field communication at predetermined periods, and to convert a wireless signal into an electrical signal, when a wireless signal is received.

The near field communication information of the terminal of the counterpart of the ride reservation is also received together with the whereabouts unknown notification. Accordingly, the ride reservation processing unit 21 determines whether or not the near field communication information of the terminal of the counterpart of the ride reservation is included in the signal that is received through the near field communication unit 24. In the case where a signal including the near field communication information of the terminal of the counterpart, is received, the ride reservation processing unit 21 transmits a response to the terminal of the counterpart through the near field communication unit 24. For example, the response is a message including the user ID or the like, and indicating being the counterpart of the ride reservation. Additionally, in the case where the near field communication scheme is a not a scheme which enables transmission of a response to a received signal, a response is not transmitted to the terminal of the counterpart of the ride reservation. The ride reservation processing unit 21 displays, on the display unit 204, an approach notification notifying of approach of the counterpart of the ride reservation.

In the service completion process, the ride reservation processing unit 21 receives input, by a user operation, indicating service completion. The ride reservation processing unit 21 transmits a completion notification regarding the service to the center server 300. Furthermore, the ride reservation processing unit 21 deletes the ride reservation information for the service from the predetermined memory area in the main memory unit 202. The ride reservation processing unit 11 of the in-vehicle device 100 of driver receives incentive information from the center server 300, and outputs the same to the display unit.

The near field communication information storage unit 25 holds the near field communication information of the user terminal 200. For example, the near field communication information storage unit 25 is created in a memory area in the auxiliary storage unit 203. At the time of transmission, to the center server 300, of a ride reservation request or an OK response for a ride reservation request, the ride reservation processing unit 21 reads the near field communication information of the user terminal 200 from the near field communication information storage unit 25, and transmits the near field communication information to the center server 300, together with the ride reservation request or the OK response.

### <Flow of Processing>

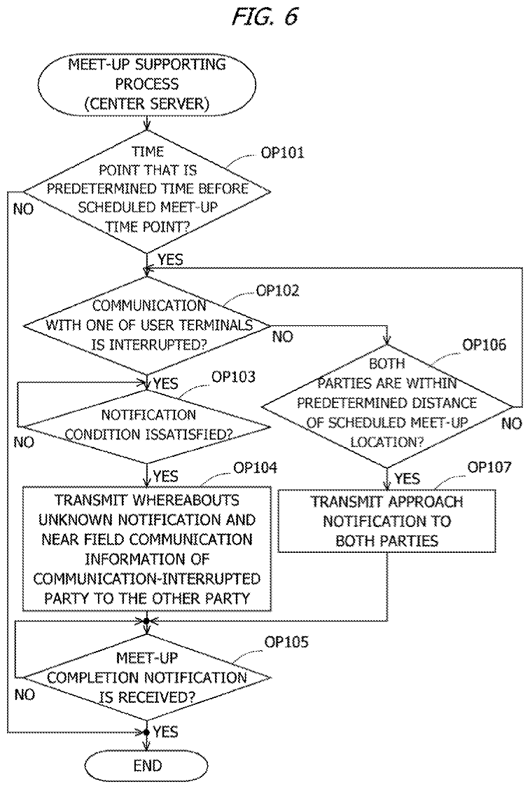

FIG. 6 is an example of a flowchart of the meet-up supporting process by the center server 300. The process illustrated in FIG. 6 is repeatedly performed every predetermined period for each piece of ride reservation information held in the reservation information DB 36, for example. A performer of the process illustrated in FIG. 6 is the processor 301 of the center server 300, for example, but a description will be given with reference to FIG. 6, taking a functional component as the performer for the sake of convenience.

In OP101, the reservation processing unit 31 determines, with respect to target ride reservation information, whether or not a time point that is a predetermined time before the scheduled meet-up time is reached. In the case where a time point that is a predetermined time before the scheduled meet-up time is reached (OP101: YES), the process proceeds to OP102. In the case where a time point that is a predetermined time before the scheduled meet-up time is not yet reached (OP101: NO), the process illustrated in FIG. 6 is ended, and the process illustrated in FIG. 6 is started again after a predetermined period.

In OP102, the reservation processing unit 31 determines, with respect to the target ride reservation information, whether or not communication with one of the in-vehicle device 100 of the driver or the user terminal 200 of the vehicle ride seeker is interrupted. Interruption of communication with one of the in-vehicle device 100 of the driver or the user terminal 200 of the vehicle ride seeker is detected by failure of reception of position information that is received every predetermined period, or by detection of disconnection of a communication session, for example.

In the case where interruption of communication with one of the in-vehicle device 100 of the driver or the user terminal 200 of the vehicle ride seeker is detected (OP102: YES), the process proceeds to OP103. In the case where interruption of connection is not detected for either of the in-vehicle device 100 of the driver and the user terminal 200 of the vehicle ride seeker (OP102: NO), the process proceeds to OP106.

Processes in OP103 and OP104 are processes that are performed when interruption of communication with one of the in-vehicle device 100 of the driver or the user terminal 200 of the vehicle ride seeker is detected. In OP103, the reservation processing unit 31 determines whether or not a notification condition for the whereabouts unknown notification is satisfied. A notification condition for the whereabouts unknown notification is one or a combination of arrival of the time point that is a predetermined time before the scheduled meet-up time, entering of the terminal with which communication is continued into an area including the scheduled meet-up location, and falling of a distance, of the terminal with which communication is continued, from the scheduled meet-up location to below a predetermined distance, for example. Additionally, the time point that is a predetermined time before the scheduled meet-up time, which is one notification condition for the whereabouts unknown notification, is a time point that is after the time point, in OP101, that is a predetermined time before the scheduled meet-up time. However, such a case is not restrictive.

In the case where the notification condition for the whereabouts unknown notification is satisfied (OP103: YES), the process proceeds to OP104. In the case where the notification condition for the whereabouts unknown notification is not satisfied (OP103: NO), a standby state is maintained until the notification condition for the whereabouts unknown notification is satisfied. Detection of interruption of communication with one of the in-vehicle device 100 of the driver or the user terminal 200 of the vehicle ride seeker, and satisfaction of the notification condition for the whereabouts unknown notification are an example of satisfaction of “first condition”.

In OP104, the reservation processing unit 31 transmits, to the one terminal with which communication is continued, through the terminal communication unit 33, the whereabouts unknown notification and the near field communication information of the one with respect to which interruption of communication is detected.

In OP105, the reservation processing unit 31 determines whether or not a meet-up completion notification is received, through the terminal communication unit 33, from at least one of the in-vehicle device 100 of the driver or the user terminal 200 of the vehicle ride seeker. In the case where a meet-up completion notification is received from at least one of the in-vehicle device 100 of the driver or the user terminal 200 of the vehicle ride seeker (OP105: YES), the process illustrated in FIG. 6 is ended for the target ride reservation information, and the process in FIG. 6 is thereafter not performed for the target ride reservation information.

Processes in OP106 and OP107 are processes that are performed when interruption of communication is not detected for either of the in-vehicle device 100 of the driver and the user terminal 200 of the vehicle ride seeker. In OP106, the reservation processing unit 31 determines whether or not both of the in-vehicle device 100 of the driver and the user terminal 200 of the vehicle ride seeker entered within a predetermined distance of the scheduled meet-up location. Determination in OP106 is performed based on the position information of the in-vehicle device 100 and the user terminal 200.

In the case where both the in-vehicle device 100 of the driver and the user terminal 200 of the vehicle ride seeker are detected to have entered within a predetermined distance of the scheduled meet-up location (OP106: YES), the process proceeds to OP107. In the case where entering of both the in-vehicle device 100 of the driver and the user terminal 200 of the vehicle ride seeker within a predetermined distance of the scheduled meet-up location is not detected (OP106: NO), the process proceeds to OP102.

In OP107, the reservation processing unit 31 transmits an approach notification to the in-vehicle device 100 of the driver and the user terminal 200 of the vehicle ride seeker through the terminal communication unit 33. Then, the process proceeds to OP105, and when a meet-up completion notification is received from one of the in-vehicle device 100 of the driver or the user terminal 200 of the vehicle ride seeker (OP105: YES), the process illustrated in FIG. 6 is ended for the target ride reservation information, and the process illustrated in FIG. 6 is thereafter not performed for the target ride reservation information.

Additionally, the meet-up supporting process illustrated in FIG. 6 is merely an example, and the meet-up supporting process by the center server 300 is not limited to the process illustrated in FIG. 6.

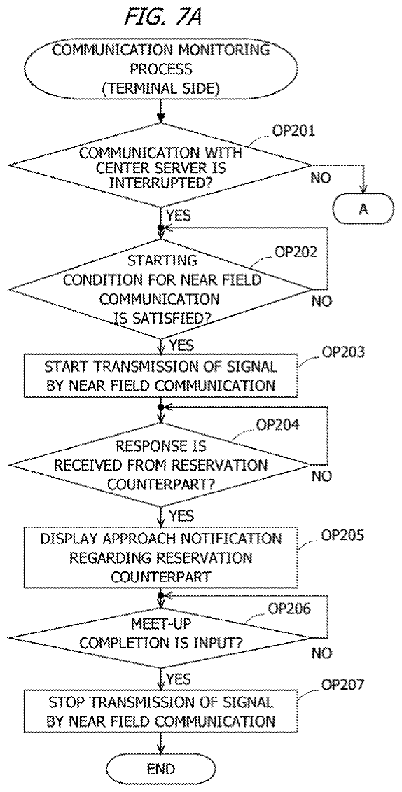

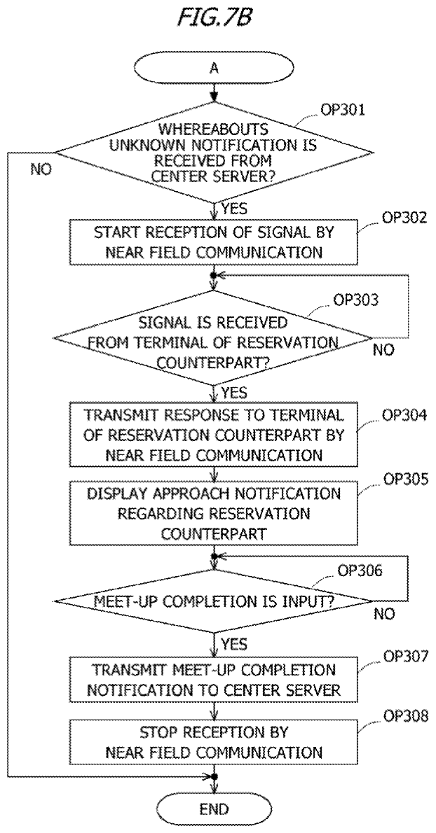

FIGS. 7A and 7B are examples of a flowchart of the communication monitoring process by the in-vehicle device 100 or the user terminal 200. Processes illustrated in FIGS. 7A and 7B are repeatedly performed every predetermined period for each piece of ride reservation information held in the main memory unit 102 or 202, for example. A performer of the processes illustrated in FIGS. 7A and 7B is the processor 101 or 201 of the in-vehicle device 100 or the user terminal 200 but a description will be given with reference to FIGS. 7A and 7B, taking a functional component as the performer for the sake of convenience. Furthermore, the description of FIGS. 7A and 7B is given taking the user terminal 200 as the performer for the sake of convenience but the same thing applies to a case where the in-vehicle device 100 is the performer.

In OP201, the ride reservation processing unit 21 determines whether or not communication with the center server 300 is interrupted. In the first embodiment, interruption of communication with the center server 300 is interruption of communication with the network N1, for example. Interruption of communication with the center server 300 is detected by the server communication unit 23 based on a state of reception of radio waves by the communication unit 206A, for example.

In the case where interruption of communication with the center server 300 is detected (OP201: YES), the process proceeds to OP202. In the case where interruption of communication with the center server 300 is not detected (OP201: NO), the process proceeds to OP301 in FIG. 7B.

Processes from OP202 to OP207 are processes that are performed when interruption of communication with the center server 300 is detected. In OP202, the ride reservation processing unit 21 determines whether or not a starting condition for near field communication is satisfied. In the case where a starting condition for near field communication is satisfied (OP202: YES), the process proceeds to OP203. In the case where a starting condition for near field communication is not satisfied (OP202: NO), a standby state is maintained until the starting condition for near field communication is satisfied. Detection of interruption of communication with the center server 300, and satisfaction of the starting condition for near field communication are examples of satisfaction of “second condition”.

In OP203, the ride reservation processing unit 21 instructs the near field communication unit 24 to start operating as the transmitter of signals, and in response to the instruction, the near field communication unit 24 causes the communication unit 206B to start operating as the transmitter. A signal that is transmitted by the communication unit 206B includes the near field communication information of the user terminal 200.

In OP204, the ride reservation processing unit 21 determines whether or not a response is received from the terminal of the counterpart of the ride reservation through the near field communication unit 24. For example, a response includes a user ID of the counterpart of the ride reservation, and whether or not the response is from the terminal of the counterpart of the ride reservation is determined based on whether or not the user ID of the reservation counterpart matches the ride reservation information that is held in the main memory unit 202.

In the case where a response is received from the terminal of the counterpart of the ride reservation through the near field communication unit 24 (OP204: YES) the process proceeds to OP205. In the case where a response is not received from the terminal of the counterpart of the ride reservation through the near field communication unit 24 (OP204: NO), a standby state is maintained until the response is received. Additionally, if a response from the terminal of the counterpart of the ride reservation is not received even after a lapse of a predetermined time from the scheduled meet-up time, for example, the process illustrated in FIG. 7A may be ended.

In OP205, because a response is received from the terminal of the counterpart of the ride reservation by near field communication, the ride reservation processing unit 21 displays, on the display unit 204, an approach notification regarding the counterpart of the ride reservation.

In OP206, the ride reservation processing unit 21 determines whether or not meet-up completion is input by a user operation. In the case where meet-up completion is input (OP206: YES), the process proceeds to OP207. In the case where meet-up completion is not input (OP206: NO), a standby state is maintained until meet-up completion is input.

In OP207, the ride reservation processing unit 21 instructs the near field communication unit 24 to stop transmission of signals by near field communication. The near field communication unit 24 thereby causes transmission of signals from the communication unit 206B to stop, and transmission of signals from the user terminal 200 by near field communication is stopped. Furthermore, the ride reservation processing unit 21 deletes the ride reservation information from the main memory unit 202. Then, the process illustrated in FIG. 7A is ended.

Additionally, in the case where communication with the center server 300 is already restored at a time point of input of meet-up completion in OP206, the ride reservation processing unit 21 may transmit a meet-up completion notification to the center server 300 through the server communication unit 23.

The process illustrated in FIG. 7B is a process that is performed in a case where communication with the center server 300 is not interrupted. In OP301, the ride reservation processing unit 21 determines whether or not a whereabouts unknown notification is received from the center server 300 through the server communication unit 23. In the case where a whereabouts unknown notification is received (OP301: YES), the process proceeds to OP302. In the case where a whereabouts unknown notification is not received (OP301: NO), the process illustrated in FIG. 7B is ended.

In OP302, the ride reservation processing unit 21 instructs the near field communication unit 24 to start operating as the receiver for near field communication. The near field communication unit 24 thereby causes the communication unit 2065 to start operating as the receiver.

In OP303, the ride reservation processing unit 21 determines whether or not a signal that is transmitted from the terminal of the counterpart of the ride reservation is received through the near field communication unit 24. The near field communication information of the terminal of the counterpart of the ride reservation is also received together with the whereabouts unknown notification. The ride reservation processing unit 21 determines whether or not a signal that is transmitted from the terminal of the counterpart of the ride reservation is received, based on whether or not the near field communication information of the terminal of the counterpart of the ride reservation is included in the signal that is received through the near field communication unit 24.

In the case where a signal that is transmitted from the terminal of the counterpart of the ride reservation is received through the near field communication unit 24 (OP303: YES), the process proceeds to OP304. In the case where a signal that is transmitted from the terminal of the counterpart of the ride reservation is not received through the near field communication unit 24 (OP303: NO), a standby state is maintained until the signal is received. Additionally, if a response from the terminal of the counterpart of the ride reservation is not received even after a lapse of a predetermined time from the scheduled meet-up time, for example, the process illustrated in FIG. 7B may be ended.

In OP304, the ride reservation processing unit 21 transmits a response to the terminal of the counterpart of the ride reservation through the near-field communication unit 24. The response includes the user ID of the user terminal 200, for example.

In OP305, because a signal is received from the terminal of the counterpart of the ride reservation by near field communication, the ride reservation processing unit 21 causes the display unit 204 to display an approach notification regarding the counterpart of the ride reservation.

In OP306, the ride reservation processing unit 21 determines whether or not meet-up completion is input by a user operation. In the case where meet-up completion is input (OP306: YES), the process proceeds to OP307. In the case where meet-up completion is not input (OP306: NO), a standby state is maintained until meet-up completion is input.

In OP307, the ride reservation processing unit 21 transmits a meet-up completion notification to the center server 300 through the server communication unit 23.

In OP308, the ride reservation processing unit 21 instructs the near field communication unit 24 to stop reception of signals by near field communication. The near field communication unit 24 thereby causes reception of signals from the communication unit 206B to stop, and reception of signals from the user terminal 200 by near field communication is stopped. Furthermore, the ride reservation processing unit 21 deletes the ride reservation information from the main memory unit 202. Then, the process illustrated in FIG. 7B is ended.

Additionally, the communication monitoring process by the in-vehicle device 100 or the user terminal 200 illustrated in FIGS. 7A and 7B is a merely an example, and is not restrictive. For example, in the case where the near field communication scheme does not transmit a response to a received signal, the processes in OP204, OP205, and OP304 are omitted.

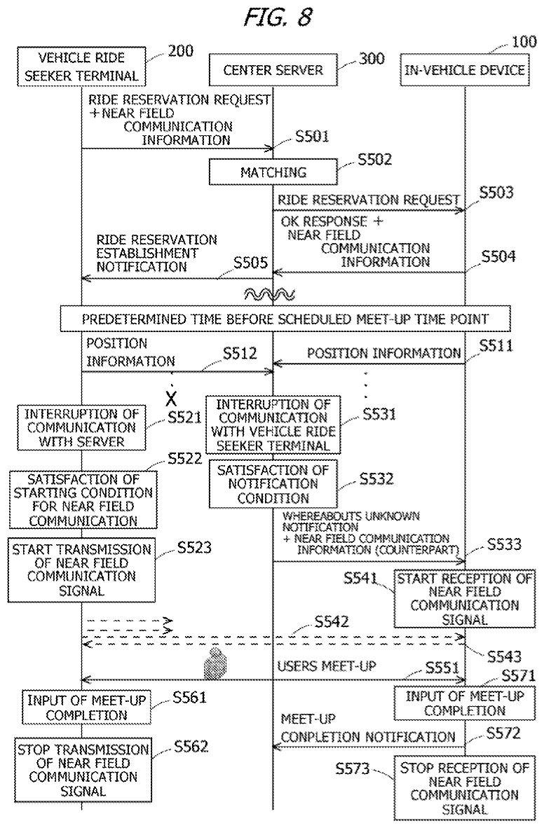

FIG. 8 is a diagram, illustrating a specific example of a sequence of processes by the ride-sharing service providing system 1 according to the first embodiment. The example illustrated in FIG. 8 indicates a sequence of processes from a ride reservation request for the ride-sharing service to meeting up of the vehicle ride seeker and the driver.

In S501, a vehicle ride seeker performs operation for a ride reservation request by the user terminal 200, and the user terminal 200 transmits the ride reservation request and the near field communication information to the center server 300. In S501, the user ID, the desired boarding location, the desired alighting location, and the desired traveling time of the vehicle ride seeker, and the near field communication information of the user terminal 200 are also transmitted from the user terminal 200, together with the ride reservation request, for example.

In S502, the center server 300 receives the ride reservation request and the near field communication information from the user terminal 200, and performs matching with a driver according to the conditions of the vehicle ride seeker. In S503, the center server 300 transmits the ride reservation request to the in-vehicle device 100 of the matched driver. In S503, ride reservation information (information about the vehicle ride seeker, the scheduled meet-up location, the scheduled meet-up time, the desired alighting location, the desired arrival time, etc.) is also transmitted from the center server 300, together with the ride reservation request.

In S504, the in-vehicle device 100 presents the ride reservation information received together with the ride reservation request from the center server 300 to the driver, and when an acceptance operation is input by the driver, an OK response and the near field communication information of the in-vehicle device 100 are transmitted to the center server 300.

In S505, the center server 300 receives the OK response and the near field communication information from the in-vehicle device 100, and transmits a ride reservation establishment notification to the user terminal 200. In S505, the ride reservation information and information about the driver are also transmitted from the center server 300, together with the ride reservation establishment notification.

Then, when a time point that is a predetermined time before the scheduled meet-up time is reached, the meet-up supporting process (FIG. 6, OP101: YES) is started at the center server 300. Furthermore, the in-vehicle device 100 and the user terminal 200 start transmission of position information to the center server 300 (S511, S512), and the communication monitoring process (FIGS. 7A and 7B) is started.

In S521, for example, the user terminal 200 detects that the vehicle ride seeker moved out of a communication range of WiFi and that, communication between the user terminal 200 and the center server 300 is interrupted (FIG. 11, OP201: YES). In S522, the user terminal 200 detects falling of the distance from the scheduled meet-up location to below a predetermined distance due to movement of the vehicle ride seeker, for example, and detects that a starting condition for near field communication is satisfied (FIG. 7A, OP202: YES). In S523, the user terminal 200 starts operating as the transmitter for near field communication (FIG. 7A, OP203). In FIG. 8, communication by near field communication is indicated by dotted lines.

In S531, the center server 300 detects interruption of communication with the user terminal 200 (FIG. 6, OP102: YES). In S532, entering of the in-vehicle device 100 into a range of a predetermined distance from the scheduled meet-up location is detected, for example, and satisfaction of the notification condition is detected (FIG. 6, OP103: YES). In S533, the center server 300 transmits the whereabouts unknown notification and the near field communication information of the user terminal 200 to the in-vehicle device 100 (FIG. 6, OP104).

In S541, the in-vehicle device 100 receives the whereabouts unknown notification from the center server 300 (FIG. 7B, OP301: YES), and starts operating as the receiver for near field communication (FIG. 7B, OP302). In S542, the distance between the in-vehicle device 100 and the user terminal 200 becomes a distance enabling near field communication due to the in-vehicle device 100 or the user terminal 200 moving, and the in-vehicle device 100 receives a signal that is transmitted from the user terminal 200 (FIG. 73, OP303: YES). In S543, the in-vehicle device 100 transmits a response to the user terminal 200 by near field communication (FIG. 7B, OP304). Furthermore, the in-vehicle device 100 displays an approach notification regarding the vehicle ride seeker (FIG. 7B, OP305), and notifies the driver of approach of the vehicle ride seeker.

For its part, the user terminal 200 receives the response from the in-vehicle device 100 by near field communication (FIG. 7A, OP204: YES), displays an approach notification regarding the driver on the display unit 204 (FIG. 7A, OP205), and notifies the vehicle ride seeker of approach of the driver.

Because the in-vehicle device 100 and the user terminal 200 each display an approach notification regarding the other party, the driver and the vehicle ride seeker may recognize that the driver and the vehicle ride seeker are approaching each other, and are made to pay attention to the surroundings to find each other.

In S551, the driver and the vehicle ride seeker meet up with each other, and the vehicle, ride seeker gets in the vehicle 10.

In S561, the vehicle ride seeker inputs meet-up completion to the user terminal 200 (FIG. 7A, OP206: YES), However, in S561, the vehicle ride seeker is present around the scheduled meet-up location, and communication with the center server 300 is still interrupted, and thus, a meet-up completion notification is not transmitted from the user terminal 200 to the center server 300. In S562, the user terminal 200 stops transmission of signals by near field communication (FIG. 7A, OP207).

With the in-vehicle device 100, meet-up completion is input in 3571 by the driver (FIG. 7B, OP306: YES). For example, the in-vehicle device 100 is communicating with the center server 300 through a carrier network such as LTE, and communication with the center server 300 is continued even around the scheduled meet-up location. Accordingly, in 3572, the in-vehicle device 100 transmits a meet-up completion notification to the center server 300 (FIG. 73, OP307), and the center server 300 receives the notification (FIG. 6, OP105: YES) In S573, the in-vehicle device 100 stops the reception process for near field communication (FIG. 73, OP308).

The example illustrated in FIG. 8 describes a case where communication between the user terminal 200 of the vehicle ride seeker and the center server 300 is interrupted. In the case where communication between the in-vehicle device 100 and the center server 300 is interrupted, the in-vehicle device 100 and the user terminal 200 are switched for the processes from S521 in the example illustrated in FIG. 3. Additionally, in the case where the near field communication scheme is a not a scheme which transmits a response to a received signal, the process in S543 is not performed.

### <Operations and Effects of First Embodiment>

In the first embodiment, when interruption of communication with the center server 300 is detected, the in-vehicle device 100 or the user terminal 200 starts operating as the transmitter for near field communication The user terminal 200 or the in-vehicle device 100 as the counterpart of a ride reservation is notified, by the center server 300, of the near field communication information of the in-vehicle device 100 or the user terminal 200, communication of which with the center server 300 is interrupted. The user terminal 200 or the in-vehicle device 100 as the counterpart of the ride reservation thereby starts operating as the receiver for near field communication. When presence of each other is detected by near field communication, the driver and the vehicle ride seeker are notified of the approach notification by the in-vehicle device 100 and the user terminal 200, and the driver and the vehicle ride seeker are enabled to easily find each other. Furthermore, even in the case where communication with the center server 300 is interrupted, the possibility of the driver and the vehicle ride seeker, for whom a ride reservation for the ride-sharing service is established, meeting up with each other may be increased.

With respect to near field wireless communication, a communication range is about 10 meters at the maximum for BLE, for example. Accordingly, in the first embodiment, the driver and the vehicle ride seeker may be notified of the approach notification when the two parties approach a range where the two parties are able to visually recognize each other, and the driver and the vehicle ride seeker may thus easily find each other.

Furthermore, in the first embodiment, near field communication is started at the in-vehicle device 100 or the user terminal 200 when the starting condition for near field communication or the notification condition is satisfied. A period when near field communication is performed may thereby be limited and reduced, and power consumption of the in-vehicle device 100 or the user terminal 200 may be reduced.

### Example Modification

In the first embodiment, in near field communication, the terminal, communication of which with the center server 300 is interrupted, becomes the transmission side, and the terminal, communication of which with the center server 300 is continued, becomes the reception side. Alternatively, in near field communication, the terminal, communication of which with the center server 300 is interrupted, may be made the reception side, and the terminal, communication of which with the center server 300 is continued, may be made the transmission side.

In this case, recognition of the other part by near field communication is not performed unless the terminals, for which a ride reservation is established, are notified of the near field communication information before communication with the center server 300 is interrupted. Accordingly, in an example modification, the center server 300 transmits the near field communication information of the vehicle ride seeker to the in-vehicle device 100 of the driver, together with the ride reservation request. Furthermore, the center server 300 transmits the near field communication information of the in-vehicle device 100 of the driver to the user terminal 200 of the vehicle ride seeker, together with the ride reservation establishment notification.

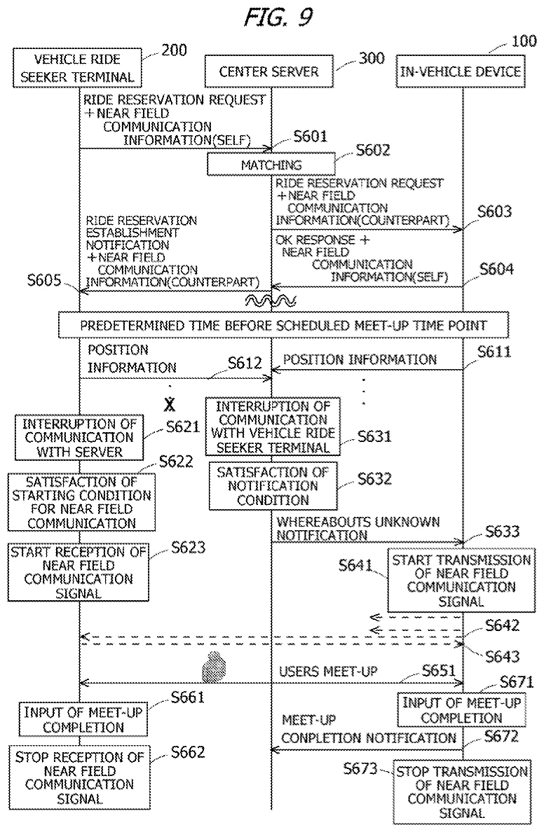

FIG. 9 is a diagram illustrating a specific example of a sequence of processes for the ride-sharing service providing system 1 according to the example modification. The example illustrated in FIG. 9 indicates a sequence of processes from a ride reservation request for the ride-sharing service to meeting up of the vehicle ride seeker and the driver.

In S601, a vehicle ride seeker performs operation for a ride reservation request by the user terminal 200, and the user terminal 200 transmits the ride reservation request and the near field communication information to the center server 300. In S602, the center server 300 receives the ride reservation request and the near field communication information from the user terminal 200, and performs matching with a driver according to the conditions of the vehicle ride seeker.

In S603, the center server 300 transmits the ride reservation request and the near field communication information of the user terminal 200 to the in-vehicle device 100 of the matched driver. In S604, the in-vehicle device 100 presents the ride reservation information received together with the ride reservation request from the center server 300 to the driver, and when an acceptance operation is input by the driver, an OK response and the near field communication information of the in-vehicle device 100 are transmitted to the center server 300.

In S605, the center server 300 receives the OK response and the near field communication information from the in-vehicle device 100, and transmits a ride reservation establishment notification and the near field communication information of the in-vehicle device 100 to the user terminal 200.

Then, when a time point that is a predetermined time before the scheduled meet-up time is reached, the meet-up supporting process (FIG. 6, OP101: YES) is started at the center server 300. Furthermore, the in-vehicle device 100 and the user terminal 200 start transmission of position information to the center server 300 (S611, S612), and the communication monitoring process (FIGS. 7A and 7B) is started.

In S621, for example, the user terminal 200 detects that the vehicle ride seeker moved out of a communication range of WiFi and that communication between the user terminal 200 and the center server 300 is interrupted (FIG. 7A, OP201: YES). In S622, the user terminal 200 detects falling of the distance from the scheduled meet-up location to below a predetermined distance due to movement of the vehicle ride seeker, for example, and detects that, the starting condition for near field communication is satisfied (FIG. 7A, OP202: YES). In S623, the user terminal 200 starts operating as the receiver for near field communication (FIG. 7A; start of transmission in OP203 is changed to start of reception).

In S631, the center server 300 detects interruption of communication with the user terminal 200 (FIG. 6, OP102: YES). In S632, entering of the in-vehicle device 100 into a range of a predetermined distance of the scheduled meet-up location is detected, for example, and satisfaction of the notification condition is detected (FIG. 6, OP103: YES). In S633, the center server 300 transmits the whereabouts unknown notification to the in-vehicle device 100 (FIG. 6, OP104).

In S641, the in-vehicle device 100 receives the whereabouts unknown notification from the center server 300 (FIG. 7B, OP301: YES), and starts operating as the transmitter for near field communication (FIG. 7B; start of reception in OP302 is changed to start of transmission). A signal that is transmitted from the in-vehicle device 100 includes the near field communication information of the in-vehicle device 100.

In S642, the distance between the in-vehicle device 100 and the user terminal 200 becomes a distance enabling near field communication due to the in-vehicle device 100 or the user terminal 200 moving, and the user terminal 200 receives a signal that is transmitted from the in-vehicle device 100. In S643, the user terminal 200 transmits a response to the in-vehicle device 100 by near field communication (the process in OP303 in FIG. 7B is performed in OP204 in FIG. 7A). Furthermore, the user terminal 200 displays an approach notification regarding the driver (FIG. 7A, OP205), and notifies the vehicle ride seeker of approach of the driver.

For its part, the in-vehicle device 100 receives the response from the user terminal 200 by near field communication (the process in OP204 in FIG. 1A is performed in OP303 in FIG. 7B), displays an approach notification regarding the vehicle ride seeker on the display unit 104 (FIG. 7b, OP305), and notifies the driver of approach of the vehicle ride seeker.

Because the in-vehicle device 100 and the user terminal 200 each display an approach notification regarding the other party, the driver and the vehicle ride seeker may recognize that the driver and the vehicle ride seeker are approaching each other, and are made to pay attention to the surroundings to find each other.

In S651, the driver and the vehicle ride seeker meet up with each other, and the vehicle ride seeker gets in the vehicle 10.

In S661, the vehicle ride seeker inputs meet-up completion to the user terminal 200 (FIG. 7A, OP206: YES) However, in S661, the vehicle ride seeker is present around the scheduled meet-up location, and communication with the center server 300 is still interrupted, and thus a meet-up completion notification is not transmitted from the user terminal 200 to the center server 300. In S662, the user terminal 200 stops reception of signals by near field communication (FIG. 7A, OP207).

With the in-vehicle device 100, meet-up completion is input in S671 by the driver (FIG. 7b, OP306: YES). For example, the in-vehicle device 100 is communicating with the center server 300 through a carrier network such as LTE, and communication with the center server 300 is continued even around the scheduled meet-up location. Accordingly, in S672, the in-vehicle device 100 transmits a meet-up completion notification to the center server 300 (FIG. 73, OP307), and the center server 300 receives the notification (FIG. 6, OP105: YES) In S673, the in-vehicle device 100 stops the reception process for near field communication (FIG. 7B, OP308).

The example illustrated in FIG. 5 describes a case where communication between the user terminal 200 of the vehicle ride seeker and the center server 300 is interrupted. In the case where communication between the in-vehicle device 100 and the center server 300 is interrupted, the in-vehicle device 100 and the user terminal 200 are switched for the processes from S621 in the example illustrated in FIG. 9.

In the example modification, the in-vehicle device 100 and the user terminal 200 acquire the near field communication information of each other at a time point of establishment of a ride reservation based on a ride reservation request. Accordingly, for example, in the example illustrated in FIG. 9, by determining in advance which of the driver and the vehicle ride seeker is to be the transmission side, approach of each other may be grasped by near field communication even if communication with the center server 300 is interrupted for both the in-vehicle device 100 and the user terminal 200.

### Other Embodiments

The embodiment described above is an example, and the present disclosure may be changed and carried out as appropriate without departing from the gist of the present disclosure.

The technology described in the first embodiment is not limited to be applied to the ride-sharing service providing system 1, and may also be applied to a vehicle dispatch system for pick-up by a taxi, for example.

In the first embodiment and the example modification, a description is given taking the in-vehicle device 100 as the terminal to be used by the driver, but such a case is not restrictive, and the terminal to be used by the driver may be a wireless communication terminal such as the user terminal 200, such as a smartphone or a tablet terminal.

In the first embodiment and the example modification, a description is given of an example where both the in-vehicle device 100 of the driver and the user terminal 200 of the vehicle ride seeker perform the processes illustrated in FIGS. 7A and 7B, but the processes in FIGS. 7A and 7B do not necessarily have to be performed by both parties. For example, the user terminal 200 of the vehicle ride seeker may perform the process in FIG. 7A but not the process in FIG. 7B, and the in-vehicle device 100 of the driver may perform the process in FIG. 7B but not the process in FIG. 7A. In such a case, for example, the in-vehicle device 100 does not transmit signals by near field communication, and thus, the in-vehicle device 100 does not have to transmit the near field communication information of itself to the center server 300. Furthermore, in such a case, the center server 300 does not have to monitor the state of communication with the in-vehicle device 100.

Furthermore, in the first embodiment and the example modification, the in-vehicle device 100 of the driver and the user terminal 200 of the vehicle ride seeker each transmit the near field communication information to the center server 300 in response to occurrence of a ride reservation request. Alternatively, the near field communication information of each of the in-vehicle device 100 of the driver and the user terminal 200 of the vehicle ride seeker may be registered in advance in the driver information DB 34 or the vehicle ride seeker information DB 35.

Furthermore, in the first embodiment and the example modification, the near field communication information of each of the in-vehicle device 100 of the driver and the user terminal 200 of the vehicle ride seeker is transmitted to the center server 300 or from the center server 300, along with transmission of the ride reservation request, the OK response, or the whereabouts unknown notification, for example. However, such a case is not restrictive, and the near field communication information of each of the in-vehicle device 100 of the driver and the user terminal 200 of the vehicle ride seeker may be independently transmitted to the center server 300 or from the center server 300. Moreover, a transmission timing of the near field communication information of each of the in-vehicle device 100 of the driver and the user terminal 200 of the vehicle ride seeker is not limited to the timing described in the first embodiment and the example modification. It is sufficient if the near field communication information of each of the in-vehicle device 100 of the driver and the user terminal 200 of the vehicle ride seeker is notified to the counterpart device before near field communication is started between the in-vehicle device 100 of the driver and the user terminal 200 of the vehicle ride seeker.

Furthermore, in the first embodiment and the example modification, near field communication is started at the in-vehicle device 100 of the driver and the user terminal 200 of the vehicle ride seeker with interruption of communication with the center server 300 and satisfaction of the notification condition or the starting condition for near field communication as triggers. However, such a case is not restrictive, and interruption of communication with the center server 300 and satisfaction of the notification condition or the starting condition for near field communication are not necessary conditions for starting near field communication at the in-vehicle device 100 of the driver and the user terminal 200 of the vehicle ride seeker. For example, near field communication may be started at the in-vehicle device 100 of the driver and the user terminal 200 of the vehicle ride seeker, when interruption of communication with the center server 300 is determined. Alternatively, near field communication may be started at the in-vehicle device 100 of the driver and the user terminal 200 of the vehicle ride seeker, when the notification condition or the starting condition for near field communication is satisfied, regardless of occurrence/non-occurrence of interruption of communication with the center server 300, for example.

Furthermore, in the first embodiment and the example modification, the in-vehicle device 100 of the driver and the user terminal 200 of the vehicle ride seeker notify of the approach notification, in a case where a signal is received from the other party by near field communication, but such a case is not restrictive. For example, the approach notification may be issued when a radio wave reception intensity of a signal of near field communication is at or higher than a predetermined threshold. The radio wave reception intensity is higher, the smaller the distance between the two parties, and thus, because the approach notification is issued based on the threshold of the radio wave reception intensity, for example, the driver and the vehicle ride seeker may be enabled to easily visually recognize each other or to notify of the distance to each other.

The processes and means described in the present disclosure may be freely combined to the extent that no technical conflict exists.

A process which is described to be performed by one device may be performed divided among a plurality of devices. Processes described to be performed by different devices may be performed by one device. Each function is to be implemented by which hardware component (server component) in a computer system may be flexibly changed.

The present disclosure may also foe implemented by supplying a computer program for implementing a function described in the embodiment above to a computer, and by reading and executing the program by at least one processor of the computer. Such a computer program may be provided to a computer by a non-transitory computer-readable storage medium which is connectable to a system bus of a computer, or may be provided to a computer through a network. The non-transitory computer-readable storage medium may be any type of disk such as a magnetic disk (floppy (registered trademark) disk, a hard disk drive (HDD), etc.), an optical disk (CD-ROM, DVD disk, Blu-ray disk, etc.), a read only memory (ROM), a random access memory (RAM), an ERROM, an EEPROM, a magnetic card, a flash memory, an optical card, and any type of medium which is suitable for storing electronic instructions.

What is claimed is:

1. An information processing apparatus comprising
a controller configured to;
notify, when a meet-up schedule is set between users of a first wireless communication terminal and a second wireless communication terminal that are capable of communicating with the information processing apparatus through a communication network by a first wireless communication scheme, the second wireless communication terminal of identification information of the first, wireless communication terminal indicating a source of a signal in a second wireless communication scheme different from the first wireless communication scheme, through the communication network by the first wireless communication scheme.

2. The information processing apparatus according to claim 1, wherein
the first wireless communication scheme is a wireless communication scheme enabling communication with the first wireless communication terminal and the second wireless communication terminal through a predetermined relay apparatus, and
the second wireless communication scheme is a wireless communication scheme enabling direct communication between the first, wireless communication terminal and the second wireless communication terminal without use of the predetermined relay apparatus.

3. The information processing apparatus according to claim 1, wherein,
when a first condition is satisfied, the controller is configured to notify the second wireless communication terminal of the identification information of the first wireless communication terminal used for communication by the second wireless communication scheme.

4. The information processing apparatus according to claim 1, wherein
the first wireless communication terminal is configured to operate, when a second condition is satisfied, as a transmitter configured to transmit, every predetermined period, a first wireless signal including the identification information of the first wireless communication terminal indicating a source of a wireless signal in the second wireless communication scheme,
the second wireless communication terminal is configured to operate as a receiver of the wireless signal according to the second wireless communication scheme, and detect presence of the first wireless communication terminal by receiving the first wireless signal according to the second wireless communication scheme, including the identification information of the first wireless communication terminal, and
the controller is configured to notify, when a first, condition is satisfied, the second wireless communication terminal of an execution start timing of operation as the receiver of the wireless signal.

5. The information processing apparatus according to claim 1, wherein
the first wireless communication terminal is configured to operate as a transmitter configured to transmit, every predetermined period, a first wireless signal including identification information of the first wireless communication terminal indicating a source of a wireless signal in the second wireless communication scheme,
the second wireless communication terminal is configured to operate, when a second condition is satisfied, as a receiver of the wireless signal according to the second wireless communication scheme, and detects presence of the first wireless communication terminal by receiving the first wireless signal according to the second wireless communication scheme, including the identification information of the first wireless communication terminal, and
the controller is configured to notify, when a first condition is satisfied, the first wireless communication terminal of an execution start timing of operation as the receiver.

6. The information processing apparatus according to claim 1, wherein
the first condition is that the controller of the information processing apparatus determines at least one of that:
communication, through the communication network by the first wireless communication scheme, between the information processing apparatus and the first wireless communication terminal or the second wireless communication terminal is interrupted;
a distance between a scheduled meet-up location of the meet-up schedule and one of the first wireless communication terminal or the second wireless communication terminal becomes below a predetermined distance, the one for which communication with the information processing apparatus through the communication network by the first wireless communication scheme is maintained; and
it is a time point that is a predetermined time before a scheduled meet-up time point of the meet-up schedule, and
the second condition is that the first wireless communication terminal or the second wireless communication terminal determines at least, one of that:
communication with the information processing apparatus through the communication network by the first wireless communication scheme is interrupted;
a distance to the scheduled meet-up location of the meet-up schedule become below a predetermined distance; and
it is a time point that is a predetermined time before the scheduled meet-up time point of the meet-up schedule.

7. A wireless communication terminal comprising:
a first communicator compatible with a first wireless communication scheme;
a second communicator compatible with a second wireless communication scheme different from the first wireless communication scheme; and
a controller configured to:
operate as a transmitter configured to transmit, every predetermined period, a first wireless signal according to the second wireless communication scheme, the first wireless signal including identification information indicating a source of a wireless signal in the second wireless communication scheme, the identification information being of the wireless communication terminal and already notified, by an information processing apparatus capable of performing communication through a communication network, by the first wireless communication scheme, to another wireless communication terminal of a user for whom a meet-up schedule with a user of the wireless communication terminal is set by the information processing apparatus; or
operate as a receiver of the wireless signal according to the second wireless communication scheme, and to detect presence of the other wireless communication terminal by receiving a second wireless signal including identification information of the other wireless communication terminal indicating a source of a wireless signal by the second wireless communication scheme, received from the information processing apparatus.

8. An information processing method comprising:
notifying, by an information processing apparatus, when a meet-up schedule is set between users of a first wireless communication terminal and a second wireless communication terminal that are capable of. communicating with the information processing apparatus through a communication network by a first wireless communication scheme, the second wireless communication terminal of identification information of the first wireless communication terminal indicating a source of a wireless signal in a second wireless communication scheme different from the first wireless communication scheme, through the communication network by the first wireless communication scheme;
implementing, by the first wireless communication terminal, operation of a transmitter of a first wireless signal according to the second wireless communication scheme, including the identification information of the first wireless communication terminal; and
implementing, by the second wireless communication terminal, operation of a receiver of a wireless signal according to the second wireless communication scheme; and
detecting, by the second wireless communication terminal, presence of the first wireless communication terminal by receiving the first wireless signal according to the second wireless communication scheme, including the identification information of the first wireless communication terminal.
